(19) United States
(12) Patent Application Publication
(10) Pub. No.: US 2009/0017342 A1
(43) Pub. Date: Jan. 15, 2009

(54) FUEL CELL WITH SWITCHING ELECTRODES

(75) Inventors: Cody A. FRIESEN, Mesa, AZ (US); Joel R. HAYES, Chandler, AZ (US)

Correspondence Address: PILLSBURY WINTHROP SHAW PITTMAN, LLP, P.O. BOX 10500, MCLEAN, VA, 22102, US

(73) Assignee: Arizona Board of Regents for and on Behalf of Arizona State University The Brickyard, Tempe, AZ (US)

(21) Appl. No.: 11/928,381

(22) Filed: Oct. 30, 2007

Related U.S. Application Data
(60) Provisional application No. 60/871,250, filed on Dec. 21, 2006.

(51) Int. Cl. H01M 8/00; H01M 8/08

(52) U.S. Cl. 429/13; 429/12; 429/46

(57) ABSTRACT

A fuel cell includes a fuel source, an oxidizer source, and a plurality of electrodes each having a surface provided with an electrolyte. Relative movement is permitted between the electrodes and the fuel and oxidizer sources such that, when the electrodes are coupled to a load, each electrode is switched between (a) an anode condition wherein the electrode communicates with the fuel source for oxidizing the fuel and conducting electrons from the oxidized fuel to the load, and (b) a cathode condition wherein the electrode communicates with the oxidizer source and receives electrons from the load for reducing the oxidizer. The fuel cell also includes a driver to affect the relative movement between the electrodes and the fuel and oxidizer sources so as to continuously switch the electrodes between the anode and cathode conditions.

The present application claims priority to U.S. Provisional Application No. 60/871,250, filed Dec. 21, 2006, the entirety of which is incorporated herein by reference.

### BACKGROUND

1. Field

The present application relates to a fuel cell.

2. Description of Related Art

A fuel cell is a device that converts the chemical energy of a fuel (e.g., hydrogen, natural gas, methanol, gasoline, etc.) and an oxidizer (air or oxygen) into electricity. In principle, a fuel cell operates like a battery. However, unlike a battery, a fuel cell does not run down or require recharging. A fuel cell is designed to produce electricity as long as a fuel and an oxidizer are supplied.

A fuel cell typically includes two electrodes, a cathode and an anode, that are separated by an ion-conducting material. The fuel is oxidized at the anode and the oxidizer is reduced at the cathode. The oxidizer (e.g., oxygen) continuously passes over the cathode and the fuel (e.g., hydrogen) over the anode to generate electricity, heat and by-products (e.g., water). The cathodes and anodes are designed to be porous so as to allow the reactants to enter the electrodes. The electrolyte that separates the anode and cathode is an ion-conducting material. At the anode, the fuel and its electrons are disassociated by a catalyst so that the positive charge carriers/ions (protons) pass through the electrolyte or ion-conducting material while the electrons pass through an external electrical circuit that can power devices.

Because of their compactness, proton exchange fuel cells, or PEM fuel cells, are a prime candidate for transport application as well as for stationary and portable applications. PEM fuel cells use a polymer electrolyte membrane as the ion-conducting material. Their distinguishing features include, among other things, lower temperature and pressure ranges and high power density. In PEM fuel cells, the membrane is designed to conduct protons, not electrons, and prevent either gas (fuel—hydrogen or oxidizer—oxygen) from passing to the other side of the fuel cell.

While PEM fuel cells can achieve between 40 and 70 percent efficiency, they are generally extremely sensitive to contamination. For example, contamination of the membrane by carbon monoxide or metal ions significantly reduces the flow of positive carriers (e.g., hydrogen) from the anode and the cathode, which causes severe degradation in performance. Water management in the membrane is also crucial to performance of PEM fuel cells. In PEM fuel cells, the membrane must be hydrated, requiring water to be evaporated at about the same rate as it is produced. If water is evaporated too slowly, the anode will flood, preventing the fuel from reaching the catalyst and stopping the reaction. If water is evaporated too quickly, the membrane will dry and the resistance across it will increase. Eventually, the membrane could crack, creating a gas “short circuit”. In both cases, power output will drop.

### SUMMARY

In an embodiment of the invention, a fuel cell includes a fuel source, an oxidizer source, and a plurality of electrodes each having a surface provided with an electrolyte. Relative movement is permitted between the electrodes and the fuel and oxidizer sources such that, when the electrodes are coupled to a load, each electrode is switched between (a) an anode condition wherein the electrode communicates with the fuel source for oxidizing the fuel and conducting electrons from the oxidized fuel to the load, and (b) a cathode condition wherein the electrode communicates with the oxidizer source and receives electrons from the load for reducing the oxidizer. The fuel cell also includes a driver configured to affect the relative movement between the electrodes and the fuel and oxidizer sources so as to continuously switch the electrodes between the anode and cathode conditions thereby generating current flow when the electrodes are coupled to a load.

In another embodiment of the invention, there is provided a method for generating electrical current using a fuel cell including a fuel source, an oxidizer source, and a plurality of electrodes each having a surface provided with an electrolyte. The method includes coupling the electrodes to a load; and moving the electrodes and the fuel and oxidizer sources relative to one another to continuously switch each electrode between (a) an anode condition wherein the electrode communicates with the fuel source for oxidizing the fuel and conducting electrons from the oxidized fuel to the load, and (b) a cathode condition, wherein the electrode communicates with the oxidizer source and receives electrons from the load for reducing the oxidizer.

Other objects, features and advantages of the present application will become apparent from the following detailed description, the accompanying drawings, and the appended claims.

### BRIEF DESCRIPTION OF THE DRAWINGS

FIGS. 1a-b show a fuel cell in accordance with an embodiment of the invention;

FIG. 2 shows a schematic representation of the fuel cell shown in FIGS. 1a-b;

FIG. 3 shows a cross section of the fuel cell in accordance with an embodiment of the invention;

FIG. 4a is a schematic view of the electrode plate in accordance with an embodiment of the invention;

FIG. 4b shows a cross section of the electrode plate represented in FIG. 4a;

FIG. 5a represents a cross section view of the fuel cell in accordance with an embodiment of the invention;

FIG. 5b shows a schematic representation of a slip ring assembly in accordance with an embodiment of the invention; and

FIGS. 6a-b show two schematic top views of the electrodes during rotation of the electrode plate.

### DETAILED DESCRIPTION

The Figures described hereinafter illustrate various exemplary embodiments of the invention. These embodiments are in no way intended to be limiting, and are intended only as examples for facilitating an understanding of the principles of the present invention.

Where references are made to directions in this description or in the claims (e.g., up, down, bottom, top, left, right, etc.), it should be understood that these references are made with respect to the Figures for convenience of the reader. These directional references should not be regarded as limiting the invention to any particular orientation.

In an embodiment of the invention, a fuel cell includes a fuel source, an oxidizer source, and a plurality of electrodes each having a surface coated or otherwise provided with an electrolyte. The fuel cell is constructed and arranged to allow a relative movement between the electrodes and the fuel and oxidizer sources such that, when the electrodes are coupled to a load, each electrode is switched between (a) an anode condition wherein the electrolyte thereof communicates with the fuel source to receive positive fuel ions and enables the electrode to conduct electrons from the fuel source to the load, and (b) a cathode condition wherein the electrode receives electrons from the load and the electrolyte communicates with the oxidizer source for enabling reaction of the oxidizer with the fuel ions from the electrolyte. The fuel cell also includes a driver that is adapted to affect the relative movement between the electrodes and the fuel and oxidizer sources so as to continuously switch the electrodes between the anode and cathode conditions thereby generating current flow when the electrodes are coupled to a load. Because the fuel cell is adapted to operate without using a membrane, electrical losses related to membrane contamination and water management are reduced or eliminated.

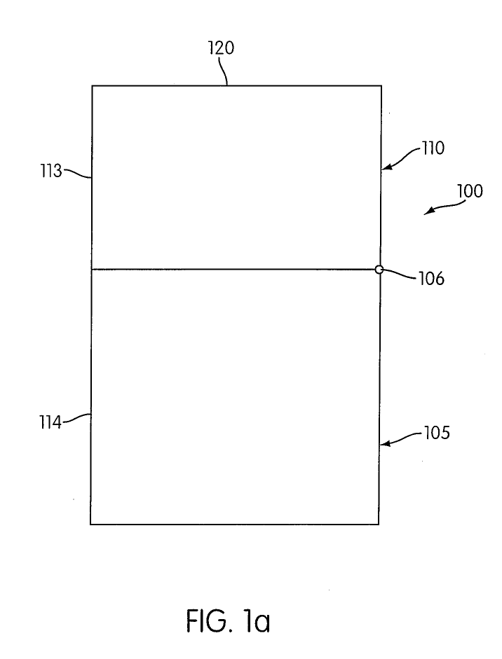

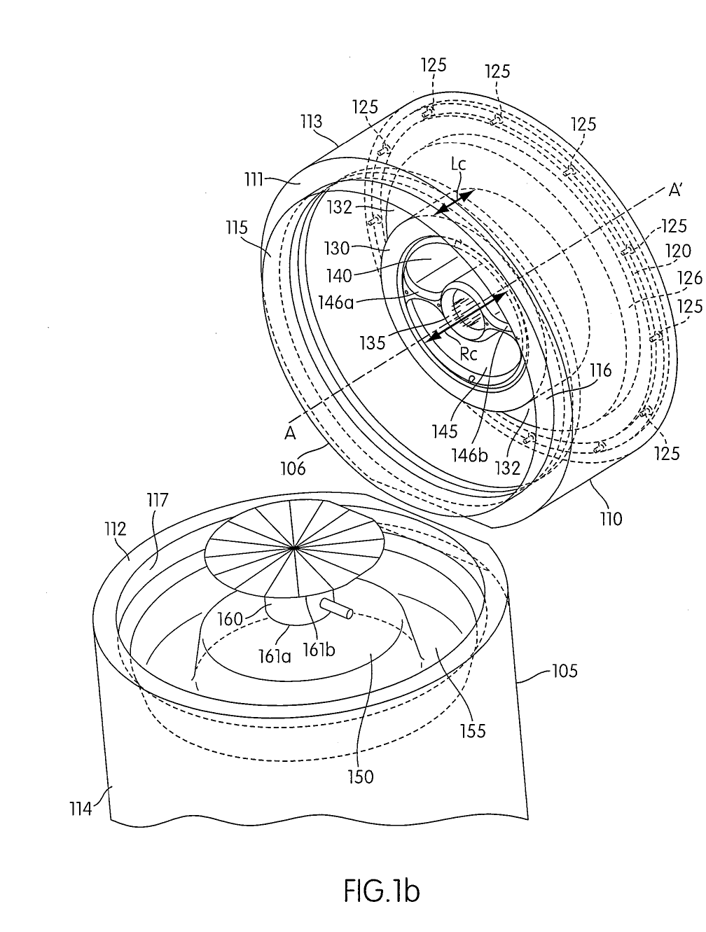

FIGS. 1a-b show a fuel cell 100 in accordance with an embodiment of the invention. Fuel cell 100 includes a housing having a lower part 105 and an upper part 110. The lower and upper parts 105, 110 have a generally cylindrical shape. The housing may have any construction or configuration, and the one illustrated herein is not intended to be limiting.

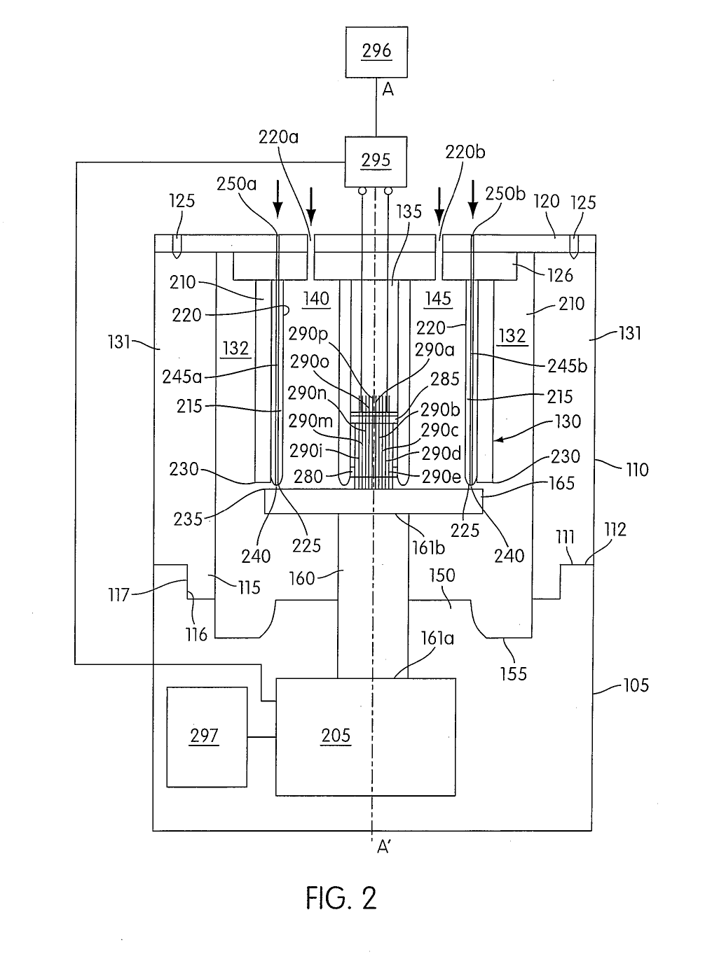

The upper part 110 is hingedly attached to the lower part 105 via a hinge 106. The upper part 110 includes a generally cylindrical outer wall 113 and a generally cylindrical bottom ring portion 115 having an exterior surface 116. The ring portion 115 is set in from the exterior of the wall 113 to create a shoulder providing bottom surface 111 on wall 113. The lower part 105 includes a generally cylindrical outer wall 114 having a top surface 112 at its edge. The lower and upper parts 105, 110 are constructed and arranged such that when the bottom surface 111 of the upper part 110 abuts the top surface 112 of the lower part 105, the exterior surface 116 of the bottom ring portion 115 engages a corresponding interior surface 117 formed in the lower part 105 and the outer wall 113 of the upper part 110 extends flush with the outer wall 114 of the lower part 105. As such, when the bottom surface 111 of the upper part 110 abuts the top surface 112 of the lower part 105, a seal is created between the upper part 110 and the lower part 105. The engagement of these parts in the closed position can be best seen in FIG. 2. In one implementation, an attachment mechanism (not shown in FIGS. 1a-b), such as a clamp, lock, latch, etc., may be used to secure the upper part 110 and the lower part 105 together in the closed position.

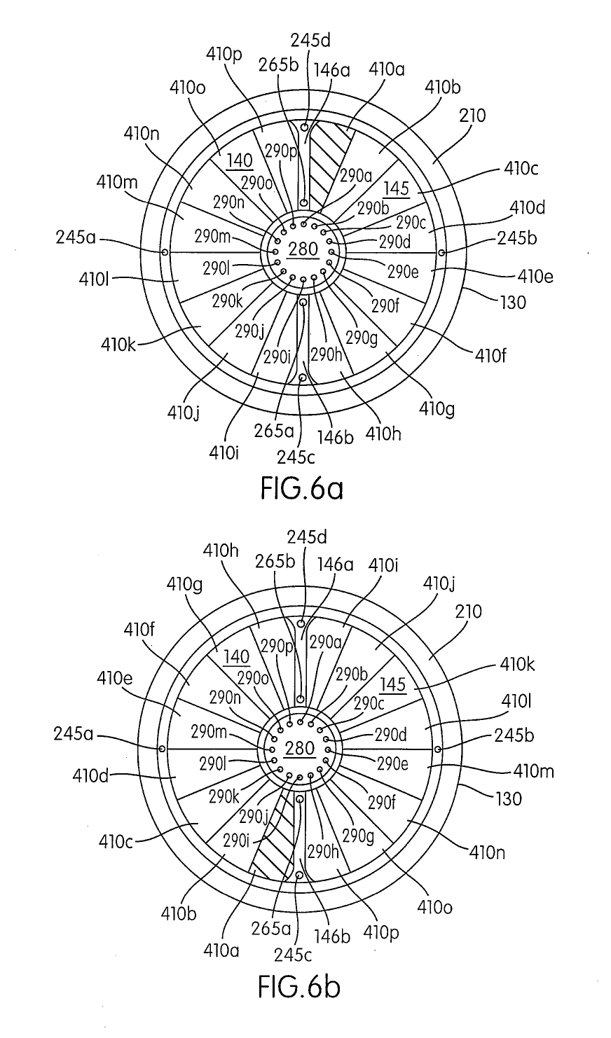

Referring to FIG. 1b, a top plate 120 is attached to the upper part 110 with a plurality of attachment devices 125 (e.g., screws). The top plate 120 includes an intermediary plate 126 (see also FIG. 6) and a container 130. The container 130 is positioned on the intermediary plate 126 at a middle portion thereof. The container 130 has a generally cylindrical shape and extends along a longitudinal axis A-A′ of the upper part 110. The container 130 has an outer diameter Rc and a length Lc that are smaller than the inner diameter and the length of the upper part 110 such that a gap 132 exists between the container 130 and the wall 131 of the upper part 110. The container 130 includes a middle tubular part 135, an oxidizer chamber 140 and a fuel chamber 145. The oxidizer chamber 140 and fuel chamber 145 have substantially the same size and are separated from each other by first and second walls 146a-b. The container 130 may have any construction or configuration and the illustrated embodiment is not intended to be limiting.

As can be appreciated from FIG. 1b, parts of the upper and lower parts 114, 115, 110 are shown in phantom so that internal components can be seen.

A cylindrical plate 150 is formed on an upper surface 155 of the lower part 105. A shaft 160 having first and second ends 161a-b is rotatably supported by the cylindrical plate 150 at first end 161a. The shaft 160 is coupled to an electrode plate 165 (shown in FIG. 2) at the second end 161b. A driver (not shown in FIGS. 1a-b), such as an electric motor, is arranged within the lower part 105 and configured to rotate the shaft 160. Rotation of the shaft 160 rotates the electrode plate 165. The electrode plate 165 may be driven by any suitable device, and is not intended to be limited to any particular driver.

Referring now to FIG. 2, this figure shows a schematic cross sectional representation of the fuel cell 100 shown in FIGS. 1a-b. In FIG. 2, the upper part 110 abuts the lower part 105. Fuel cell 100 includes the lower and upper parts 105, 110, the container 130, the shaft 160 and the top plate 120. Fuel cell 100 also includes a driver 205 configured to drive the shaft 160 to effect rotation thereof.

A pair of inlets 220a-b are provided in the upper plate 120 to supply the oxidizer and the fuel to, respectively, the oxidizer chamber 140 and the fuel chamber 145. The pressure within the oxidizer chamber 140 and fuel chamber 145 may be set to about 1 atm but may be set higher. In one embodiment, the oxidizer may be oxygen (O₂) and the fuel may be hydrogen (H₂). However, it will be appreciated that different types of fuel and/or oxidizer may be used in other embodiments of the invention.

For example, in one implementation, air may be used as a source of oxygen for the oxidizer chamber 140. The air may be delivered by a passive system (e.g., by passive exposure to ambient air), or by an active delivery system (e.g., by a blower or pump for forcing air into the chamber). It will be appreciated that the oxidizer may also be provided by an oxygen emulsion, an oxygen saturated electrolyte or an oxygen saturated perfluorocarbon/electrolyte emulsion. In another implementation, the fuel chamber 145 may be in communication with a fuel reformer adapted to convert hydrocarbons into hydrogen.

Alternatively, a “dirty” fuel may be used without the need for a reformer, since there is no membrane to contaminate. Furthermore, any contaminants (e.g, carbon monoxide) present in the fuel chamber 145 and trapped at the surface of the electrode plate 160 can then be oxidized and released (e.g., carbon dioxide) in the oxidizing environment when exposed to the rotating oxidizer chamber 140. Thus, since the operation and, thus, the efficiency of the rotary fuel cells are not adversely affected by contaminants present in the fuel, less costly fuels could be used in an embodiment of the invention.

As another example, the fuel may include formic acid or methanol.

In addition, it will be appreciated that the pressure within the fuel and oxygen chambers 135, 140 may be higher or lower than 1 atm in other embodiments of the invention.

It will be appreciated that the rotary fuel cell 100 may be adapted to operate in large ranges of pressure and temperature. For example, in an embodiment of the invention, the rotary fuel cell 100 is configured to operate in a temperature range from about 25° C. to about 500° C. In an embodiment of the invention, the rotary fuel cell 100 is configured to operate in a pressure range from about 1 psi (e.g. 0.06 atm) to about 1000 psi (e.g., 70 atm).

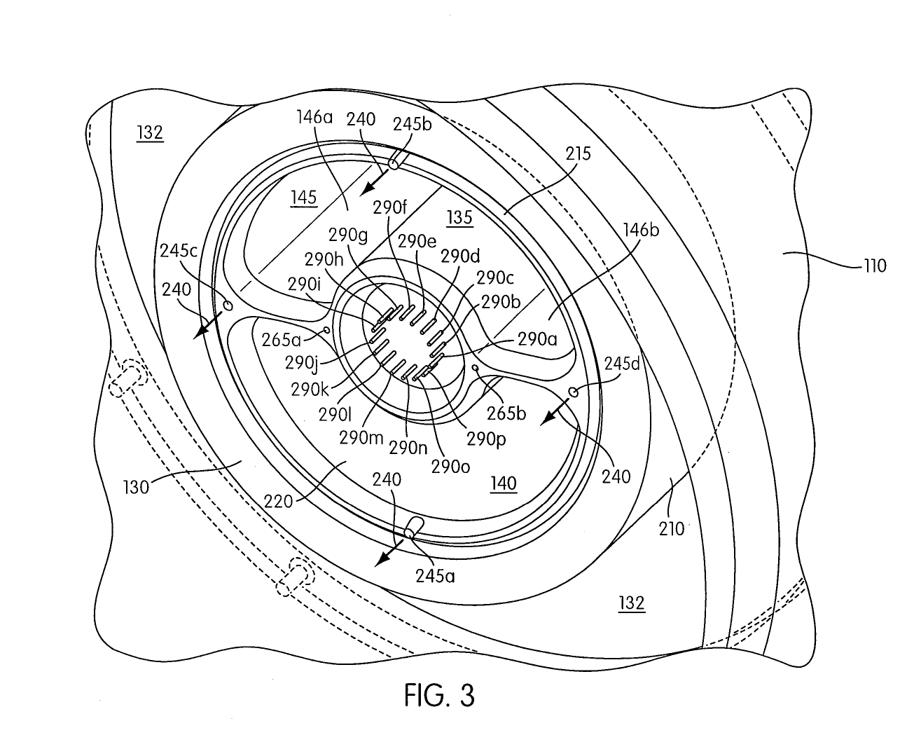

The container 130 includes an outer cylindrical portion 210 and an inner cylindrical portion 215 received within the outer cylindrical portion 210. The inner cylindrical portion 215 is secured to the outer cylindrical portion 210 and includes first and second radial walls 146a-b that extend from the interior surface 220 of the inner cylindrical portion 215 to the middle part 135 (see FIGS. 1b and 3). As shown in FIG. 2, the outer and inner cylindrical portions 210, 215 each include a bottom edge surface 225, 230 that together substantially cover the outer periphery 235 of the electrode plate 165 in a contactless manner. The use of inner and outer portions for the container 130 is not critical, and the container 130 may have other constructions as well, such as a one-piece integral construction.

A peripheral gas seal 240 is provided between the bottom surface 225 of the inner cylindrical portion 215 and the electrode plate 165 to prevent the oxidizer and the fuel from escaping their chambers 140, 145 and flowing into the gap 132 defined between the container 130 and the wall 131 of the upper part 110. The gas seal 240 is also adapted to lift the container 130 relative to the electrode plate 165 in order to prevent any contact between the outer and inner cylindrical portions 210, 215 and the electrode plate 165 during rotation of the electrode plate. Thus, the gas seal 140 may also be referred to as a gas support in an embodiment of the invention. The gas seal 240 is formed with a flow of gas supplied by first, second, third and fourth dispense ports 245a-d (see, e.g., FIG. 3). In FIG. 2, only first and second dispense ports 245a-b are represented. Each of the dispense ports 245a-d are arranged within the inner cylindrical portion 215 and connected to a respective inlet for supplying gas. For example, in FIG. 2, the first and second dispense ports 245a-b are connected to respective inlets 250a-b. The respective inlets 250a-b are coupled to a gas supply (not shown in FIG. 2). The gas used to form the first gas seal 240 may be any gas, but preferably is. Nitrogen, Argon and/or Xenon. However, it will be appreciated that other types of gas (e.g., inert gas) may be used in other embodiments of the invention to create the first gas seal 240.

Additionally, any other way of achieving a gas or other type of seal (e.g., contact) may be used, and the example herein is not limiting. A gas seal is advantageous because there is little or no friction, but in some embodiments other types of seals may be used.

Referring to FIG. 3, this figure shows a bottom view of the upper part 110 and the container 130 in accordance with an embodiment of the invention. The container 130 includes the outer cylindrical portion 210 and the inner cylindrical portion 215. The inner cylindrical portion 215 is a one piece element that includes oxidizer and fuel chambers 140, 145. FIG. 3 shows the first, second, third and fourth dispense ports 245a-d that produce the gas seal or gas support 240. As shown in FIG. 3, the third and fourth dispense ports 245c, 245d are arranged, respectively, at the junction of the interior surface 220 of the inner cylindrical portion 215 and the first and second walls 146a-b. It will be appreciated that the configuration shown in FIG. 3 is not limiting and that additional or fewer dispense ports may be provided in the inner cylindrical portion 215.

A liquid electrolyte is provided onto the electrode plate 165 by means of first and second electrolyte dispense ports 265a-b. The first and second electrolyte dispense ports 265a-b are arranged, respectively, at the junction of the wall of the middle part 135 and the first and second walls 146a-b . These electrolyte dispense ports 265a-b extend through the container 130 along walls 146a-b and are connected to respective electrolyte inlets (not shown in FIG. 3). The respective inlets are coupled to an electrolyte source. Various types of electrolytes may be used in an embodiment of the invention including, for example, an aqueous alkaline solution of potassium hydroxide or sodium hydroxide, an acidic electrolyte, a molten salt electrolyte, a molten carbonate electrolyte, sulfuric acid, phosphoric acid, triflic acid, nitric acid, sodium chloride, lithium chloride, potassium hydroxide and sodium hydroxide.

In FIG. 3, the gas seal or gas support 240 may be adapted to actively seal and lift the oxidizer and fuel chambers 140, 145 during operation of the fuel cell 100. In one implementation, in order to substantially prevent the fuel and oxidizer from diffusing into the gap 132, the gas supplied by gas seal 240 may be directed along grooves formed at the bottom surface 225 of the inner cylindrical portion 215.

The degree of fuel crossover between the chambers 140 and 145 is limited as a result of the close proximity between the bottom surface of the walls 146a-b and the top surface of the electrode plate 165. However, it will be appreciated that a gas seal may also be provided to assist in separating the chambers 140, 145. For example, grooves or separate gas dispense ports may extend along the bottom surfaces of walls 146a-b so that a gas seal flows radially to assist in separating the chambers 140, 145. Although not shown in FIG. 3, outlets may be provided within the container 130 to exhaust gas of first gas seal 240. It will be appreciated that other types of mechanisms may be used in other embodiments of the invention to seal the oxidizer and fuel chamber 140, 145.

Referring back to FIG. 2, the lower part 105 of the fuel cell 100 is adapted to support and rotate the electrode plate 165 with rotating shaft 160. Rotating shaft 160 supports the electrode plate 165 at a center thereof. During operation of the fuel cell 100, the electrode plate 165 closes the container 130 and chambers 140, 145 in a contactless manner as a result of the gas seals discussed above.

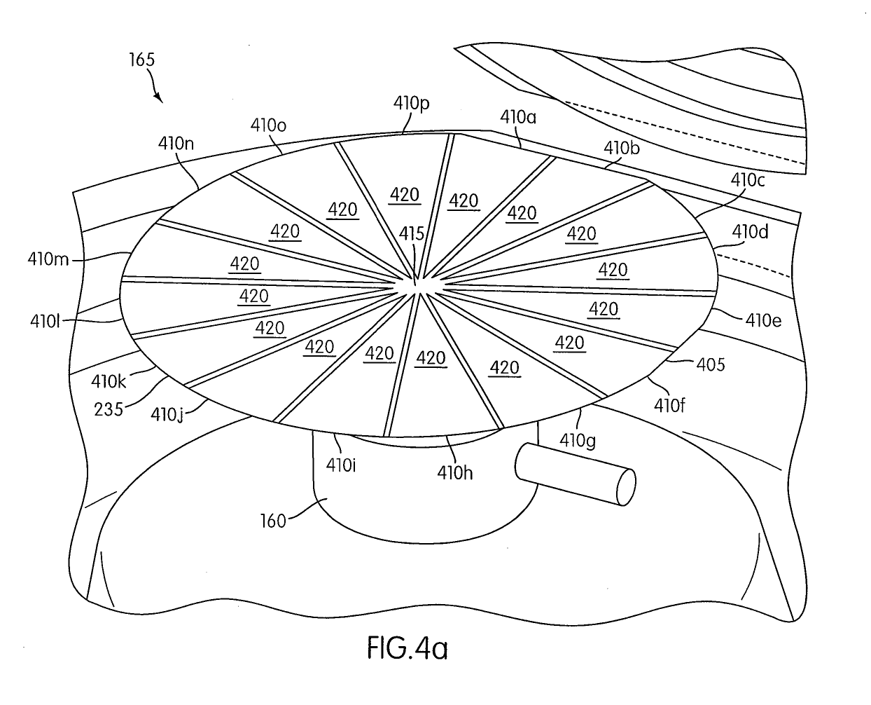

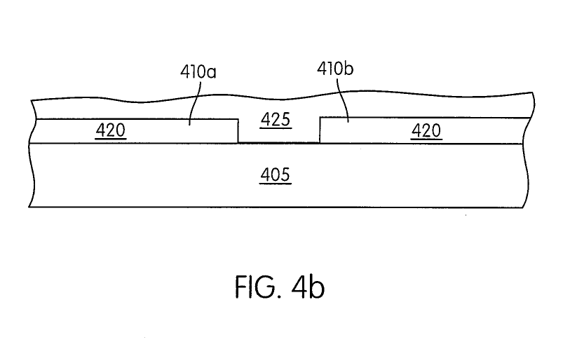

FIG. 4a is a schematic view of the electrode plate 165 in accordance with an embodiment of the invention. Electrode plate 165 comprises a substrate 405, e.g., a disc, that includes a plurality of substantially identical segments 410a-p that are spread apart or otherwise electrically isolated from one another. In one implementation, the substrate 405 is made of silicon and has a thickness that is in a range between about 100 μm and 1 mm However, it will be appreciated that other types of material could be used in other embodiments of the invention, and that the various dimensions of the substrate 405 may vary based on the relative size of the cell 100.

Each segment of the electrode plate 165 defines an electrode that extends from a center portion 415 to the outer periphery 235 of the electrode plate 165. Each segment includes a catalyst layer 420 that is adapted to facilitate the dissociation of the fuel. For example, in one implementation, the catalyst layer 420 may include a nanoporous layer of platinum. The nanoporous layer is adapted to maximize the exposure of the platinum to the fuel. In one embodiment of the invention, the nanoporous layer of platinum is about 100 nm thick. The catalyst layer 420 of each electrode may be produced using conventional physical vapor deposition (PVD) and/or chemical vapor deposition (CVD) techniques. For example, in one implementation, a mask may be produced on the substrate 405 and the catalyst layer 420 may be subsequently deposited by PVD and/or CVD. Any other configuration or materials may be used, and these examples are not intended to be limiting.

Referring now to FIG. 4b, this figure shows a cross section of the electrode plate 165 represented in FIG. 4a. An electrolyte layer 425 is coated on the electrode plate 165 to substantially cover the upper surface thereof. The electrolyte layer 425 is an ion conducting layer, which has a thickness that is in a range between about 10 nm to 10 μm. The electrolyte layer 265 may be formed with an aqueous electrolyte such as, for example, a sulfuric acid. In one embodiment of the invention, the electrolyte layer 425 is spun to a thin layer through spin off and evaporation. The surface of the electrode plate 165 may be periodically dosed to replenish the electrolyte layer 425 via the electrolyte dispense ports 265a-b. Alternatively or additionally, the electrolyte layer 425 may include a solid electrolyte such as, for example, a nafion layer. It will be appreciated that other types of electrolyte may be used to form the electrolyte layer 425.

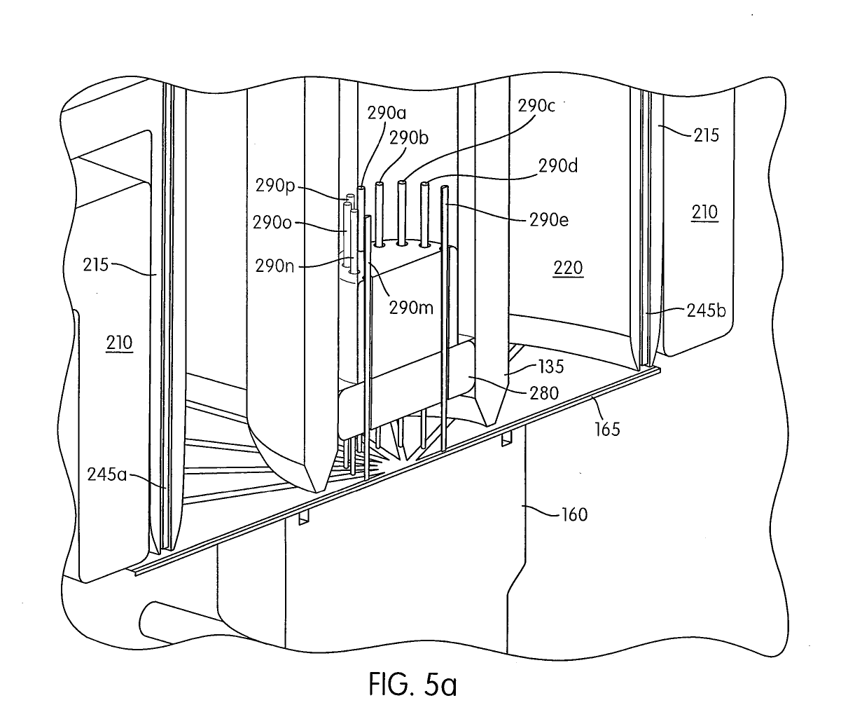

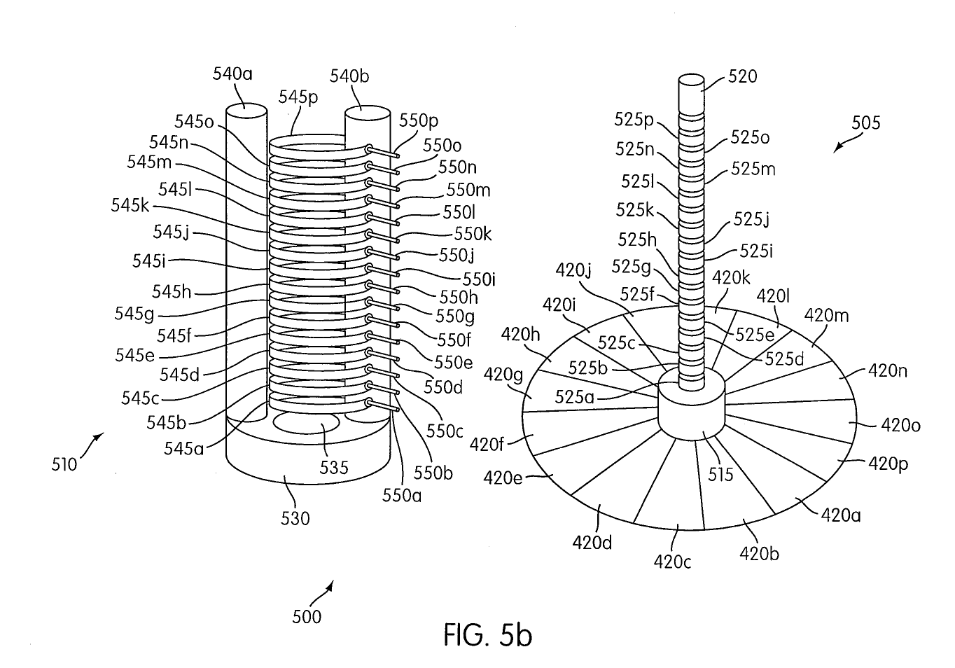

Referring back to FIG. 2, a contact rod 280 is secured within the middle part 135. Contact rod 280 includes a main body 285 in which a plurality of electrode contact elements 290a-p are arranged. Electrode contacts 290a-p consist of spring loaded rods that are adapted to apply a low spring pressure on the upper surface of the electrode plate 165. As shown in FIG. 5a, which represents a cross sectional view of the fuel cell 100 in accordance with an embodiment of the invention, the electrode contacts 290a-p are provided at the periphery of the main body 285. The pressure applied by the electrode contacts 290a-p is selected so as to maintain conductive contact, but minimize friction during rotation of the electrode contacts 290a-p on the electrode plate 165. In order to maximize the collection of current, the electrode contacts 290a-p may be coated with gold.

As will be explained in more detail below, the electrode contacts 290a-p collect the current generated by the dissociation of the fuel to power an external device 295, (see FIG. 2). As will be seen from the discussion below, electrode contacts 290a-h are negative electrode contacts and electrode contacts 290i-p are positive electrode contacts. The negative electrode contacts 290a-h are positioned to contact the electrodes in the anode condition exposed to the fuel source. This enables the negative electrode contacts to collect the disassociated electrons from those electrodes for conduction to the load. Likewise, the positive electrode contacts 290i-p are positioned to contact the electrodes in the cathode condition exposed to the oxidizer. This enables the positive electrode contacts to conduct the electrons from the load to the contacted electrodes for the cathode side reaction. Preferably, the number of electrode contacts matches the number of electrodes, but this is not critical. At least one positive electrode contact and at least one negative contact is preferable for conducting the current between electrodes in the anode and cathode conditions.

Typically, the negative electrode contacts 290a-h will be coupled to a negative terminal, and the positive electrode contacts will be coupled to a positive terminal. These terminals may have any construction or configuration, and are used to couple the fuel cell 100 to a load.

It will be appreciated that other types of mechanisms may be used in other embodiments of the invention to collect the electrons. For example, in order to reduce friction on the electrode plate 165, a slip ring assembly may be used. The slip ring assembly is attached to the electrode plate 165. In this implementation, the electrode contacts 290a-p are adapted to contact the slip ring assembly, not the upper surface of the electrode plate 165.

Referring to FIG. 5b, this figure shows a slip ring assembly 500 in accordance with an embodiment of the invention. The slip ring assembly 500 includes a first part 505 and a second part 510. First part 505 includes a base portion 515 attached to the electrode plate 165 and a rod 520 mounted to the top of the base portion 515. First and second parts 505, 510 may be arranged within the middle part 135 of the container 130.

The base portion 515 includes a plurality of contacts 525a-p that each have a first end (not shown in FIG. 5b) secured to one of the electrodes 410a-p and a second end attached to the rod 520. Second part 510 includes a bottom portion 530 having an opening 535 and two parallel members 540a-b mounted to the top of the bottom portion 530. A plurality of leaf springs 545a-p are attached to member 540b. Each leaf spring 545a-p is connected to a wire 550a-p for collecting or receiving the current. For example, leaf spring 545a-h may correspond to positive electrode contacts while leaf springs 545i-p may correspond to negative electrode contacts. The first and second parts 505, 510 are constructed and arranged such that, when the second part 510 is mounted to the first part 505, rod 520 is received in the opening 535 and each leaf spring 545a-p contacts a corresponding contact 525a-p.

In operation, the electrode plate 165 rotates about the axis of rotation or driving axis A-A′ so that relative movement is permitted between the plurality of electrodes 410a-p and the fuel and oxidizer chambers 140, 145. The oxidizer and fuel chambers 140, 145 have their openings positioned adjacent the electrode plate 165 so that the electrolyte 425 of the electrodes 410a-p is exposed to the fuel and oxidizer. During rotation of the electrode plate 165, each of the electrodes 410a-p is switched between an anode condition and a cathode condition. For example, referring to FIGS. 6a-b, these figures show a schematic top view of the electrode plate 165 at two different points in time during rotation of the electrode plate 165. FIGS. 6a-b show the container 130, including the outer cylindrical portion 210, the inner cylindrical portion 215, the middle part 135 and the first and second walls 146a-b. FIGS. 6a-b also show the contact rods 280 including the plurality of contact elements 290a-p.

In FIG. 6a, electrodes 410a-h are located within the fuel chamber 145 and electrodes 410i-p are located within the oxidizer chamber 140. Electrodes 410a-h act as the anode and the fuel contained within the fuel chamber 145 is dissociated into positive charge carriers/ions and electrons. For example, if hydrogen is used as fuel, the following anode reaction occurs at electrodes 410a-h:

2H₂→4H⁺+4e⁻ (a)

Electrons generated by the anode reaction (a) are collected by contact elements 290a-h and pass through an external circuit as a direct current that can power a useful device/load.

Referring now to FIG. 6b, electrodes 410a-h are now located within the oxidizer chamber 140 due to rotation of the electrode plate 165, while electrodes 410i-p are now located within fuel chamber 145. The positive charge carriers/ions contained in the electrolyte layer and previously produced by anode reaction (a) in fuel chamber 145 react with the oxidizer contained in the oxidizer source 140. The positive charge carriers/ions are recombined with the electrons that are returned from the external circuit via positive electrode contacts 290i-p. For example, if oxygen is used as the oxidizer, the following cathode reactions occur at electrodes 410a-h:

O₂+4e⁻→2O²⁻ (b)

2O²⁻+4H⁺+4e^{-→2}H₂O (c)

The overall global reaction at each electrode 410a-p during a full rotation of the electrode plate 165 is therefore:

2H₂+O₂→2H₂O (d)

Part of the water produced by the overall reaction (d) is spun off and evaporates. The water remaining in the electrolyte may be collected with a container positioned at the edge of the electrode plate 165. Thus, by continual rotation of the electrode plate, each of the electrodes 410a-p are continually being switched between anode and cathode conditions. This provides the current generation by disassociating fuel ions and electrons (i.e., fuel oxidation) at the electrodes in the anode condition, and reacting the oxidized fuel ions with the oxidizer and electrons returning from the load at the electrodes in the cathode condition. And continuously switching the electrodes between these anode and cathode conditions drives the current generation by transporting the oxidized fuel ions from the fuel source of the anode side to the oxidizer of the cathode side for maintaining the overall fuel cell reaction.

The current supplied to the load or useful device via the external circuit may be controlled by adjusting the rotation speed of the electrode plate 165. In one embodiment, the rotation speed of the electrode plate 165 is adjusted by means of a controller 297 arranged within the lower part 105 of the fuel cell 100, as shown in FIG. 2. In one embodiment, the rotation speed of the electrode plate 165 may be in the range from about 1 rpm to about 10000 rpm. The controller 297 is coupled to the driver 205 such that a command inputted to the controller 297 can be used to control the driver 205. In addition, a portion of the current that is collected by the external circuit 295 and supplied to the load 296 may be redirected to power the driver 205. For example, the driver 205 may be an electric motor coupled to the positive and negative terminals discussed above.

As an option, where the driver 205 is electrically powered by operation of the fuel cell 100 (i.e., a self-powered embodiment), the driver 205 may be coupled to another power supply for starting the initial operation of the cell 100. Such a power supply may be a battery, or a stationary supply (e.g., an AC wall outlet). A switch or other type of controller may be used to initially supply power from this other source to the driver 205, then switch over to supply power to the driver 205 from the fuel cell terminals so that part of the generated current thereafter powers the driver 205. This may be done after a predetermined period of time has passed, or by measuring the output of the fuel cell 100 and switching over to “self-powering” after the power generated reaches or exceeds a predetermined threshold. As another option where a battery is used, the circuit may include a recharger for recharging the battery while the fuel cell is operating.

In an alternative embodiment, the fuel cell 10 may be designed similarly to the illustrated embodiment, but the container 130 may rotate while the electrode plate remains fixed. Thus, the invention is not limited to moving the electrodes relative to stationery fuel and oxidizer sources, and instead allows for any kind of relative movement. In such an embodiment, the “switching” of the electrodes between the anode and cathode conditions would be accomplished by the movement of the fuel and oxidizer, which dictates whether a given electrode is involved in an anode or cathode side reaction. Accordingly, the term “switching” is not limited to physical movement or manipulation of the electrodes, and instead broadly refers to a change in condition, and specifically a change between the reactions it is involved in.

Although a particular configuration of the rotary fuel cell has been shown, the present invention is not limited to this configuration and a variety of other arrangements may be used in other embodiments of the invention. For example, it will be appreciated that the plate electrode of the fuel cell may be replaced by an electrode belt. The electrode belt may include a plurality of electrodes that are exposed to the fuel and oxidizer chambers. The electrode belt extends between two pivot axis and is disposed between a fuel and an oxidizer chamber. Rotation of the electrode belt about the two pivot axis expose the electrodes formed on the electrode belt to the fuel and oxidizer chambers.

Furthermore, it will be appreciated that the container 130 could include more than one fuel and/or oxidizer chambers 140, 145. For example, in one configuration, the container 130 includes a plurality of fuel and oxidizer chambers 140, 145 that are alternatively arranged in the container. In this configuration, the electrodes 410a-p can be quickly exposed to the fuel and the oxidizer.

Although the above embodiments have been described in terms of a traditional fuel cell reaction where the fuel is oxidized by the anode and the oxidized fuel is reacted with the reduced oxidizer at the cathode, the invention may cover an alkaline type cell also. In such a cell reaction, the reduced oxidizer created at the cathode would be reacted with the oxidized fuel at the anode. That is, for each electrode, the oxidizer may be reduced when the electrode is in its cathode condition by the electrons returning from the load, and the reduced oxidizer may be carried in the electrolyte and brought over with the electrode as it moves to its anode condition. In the anode condition, the fuel is oxidized, and the oxidized fuel will react with the reduced oxidizer to complete the overall fuel cell reaction. Thus, the invention is not intended to be limited to having the fuel/oxidizer reaction occur at any specific point.

As will be appreciated by one of ordinary skill in the art, the fuel cell in accordance with an embodiment of the invention is adapted to convert the chemical energy of the fuel and oxidizer into electricity without using a proton exchange membrane. The fuel cell constructed in accordance with an embodiment of the invention may be used in portable applications, such as for powering laptops, cell phones, portable audio players, wireless e-mail devices, medical equipment, or any other device for which portability by a person is desirable. However, it should be understood that the present invention may be practiced on larger scale, non-portable devices, and the benefit of portability is not intended to be limiting. To the contrary, the embodiments of the present invention are not limited to portability, but they are believed to be useable for achieving portability. For example, in one embodiment of the invention, the rotary fuel may be used in transportation applications.

The foregoing illustrated embodiment(s) have been provided solely for illustrating the structural and functional principles of the present invention and are not intended to be limiting. To the contrary, the present invention is intended to encompass all modifications, substitutions, alterations, and equivalents within the spirit and scope of the following appended claims.

What is claimed is:

1. A fuel cell comprising:
a fuel source;
an oxidizer source;
a plurality of electrodes each having a surface provided with an electrolyte;
wherein relative movement is permitted between the electrodes and the fuel and oxidizer sources such that, when the electrodes are coupled to a load, each electrode is switched between (a) an anode condition wherein the electrode communicates with the fuel source for oxidizing the fuel and conducting electrons from the oxidized fuel to the load, and (b) a cathode condition wherein the electrode communicates with the oxidizer source and receives electrons from the load for reducing the oxidizer;
a driver for affecting the relative movement between the electrodes and the fuel and oxidizer sources so as to continuously switch the electrodes between the anode and cathode conditions thereby generating current flow when the electrodes are coupled to a load.

2. A fuel cell according to claim 1, further comprising a controller for varying a rate at which said driver affects the relative movement between the electrodes and the fuel and oxidizer sources, the rate being related to an amount of current flow generated when the electrodes are coupled to a load.

3. A fuel cell according to claim 1, further comprising a housing having a pair of chambers, a first of the chambers containing the fuel source and a second of the chambers containing the oxidizer source.

4. A fuel cell according to claim 3, wherein the electrodes are provided on a disc and wherein the driver rotates the disc about a driving axis,
the chambers each having an opening and the disc being positioned adjacent the openings so that the electrolytes of the electrodes are exposed to the fuel and oxidizer sources in the chambers through the openings,
wherein, when the electrodes are coupled to the load, the rotation of the disc switches the electrodes between the anode condition with exposure to the fuel source in the first chamber and the cathode condition with exposure to the oxidizer source in the second chamber.

5. A fuel cell according to claim 4, wherein a gas bearing is provided between the housing and the disk to seal the chambers.

6. A fuel cell according to claim 4, further comprising at least one negative electrode contact and at least one positive electrode contact,
each of the at least one negative electrode contacts being positioned to contact an electrode in the anode condition to conduct electrons for conduction to the load,
each of the at least one positive electrode contacts being positioned to contact an electrode in the cathode condition to conduct electrons from the load.

7. A fuel cell according to claim 6, wherein the electrode contacts are biased towards the disc to maintain contact with the electrodes.

8. A fuel cell according to claim 6, wherein the housing has an inner chamber between the first and second chambers, the electrode contacts being disposed within the inner chamber.

9. A fuel cell according to claim 6, wherein the at least one negative electrode contact is a plurality of negative electrode contacts coupled to a negative terminal and wherein the at least one positive electrode contact is a plurality of positive electrode contacts coupled to a positive terminal.

10. A fuel cell according to claim 1, wherein the fuel is selected from the group consisting of essentially pure hydrogen, a hydrocarbon, formic acid and methanol.

11. A fuel cell according to claim 1, wherein the oxidizer is selected from the group consisting of essentially pure oxygen, oxygen present in ambient air, an oxygen emulsion, an oxygen saturated electrolyte, and an oxygen saturated perflourocarbon/electrolyte emulsion.

12. A fuel cell according to claim 1, wherein the electrolyte on each electrode is selected from the group consisting of an acidic electrolyte, an alkaline electrolyte, a molten salt electrolyte, a molten carbonate electrolyte, sulfuric acid, phosphoric acid, triflic acid, nitric acid, sodium chloride, lithium chloride, potassium hydroxide and sodium hydroxide.

13. A fuel cell according to claim 9, wherein the driver is an electric motor, and wherein the motor is coupled to the negative and positive terminals for self-powering.

14. A fuel cell according to claim 1, wherein the fuel cell is configured to operate in a temperature range from about 25° C. to about 500° C.

15. A fuel cell according to claim 1, wherein the fuel cell is configured to operate in a pressure range from about 1 psi to about 1000 psi.

16. A method for generating electrical current using a fuel cell comprising a fuel source; an oxidizer source; and a plurality of electrodes each having a surface coated with an electrolyte; the method comprising:
coupling the electrodes to a load; and
moving the electrodes and the fuel and oxidizer sources relative to one another to continuously switch each electrode between (a) an anode condition wherein the electrode communicates with the fuel source for oxidizing the fuel and conducting electrons from the oxidized fuel to the load, and (b) a cathode condition, wherein the electrode communicates with the oxidizer source and receives electrons from the load for reducing the oxidizer.

17. A method according to claim 16, further comprising varying a rate of said relative movement between the electrodes and the fuel and oxidizer sources to control the amount of current flow generated.

18. A method according to claim 17, wherein a controller is used to vary the rate of said relative movement between the electrodes and the fuel and oxidizer sources.

19. A method according to claim 18, further comprising a housing having a pair of chambers, a first of the chambers containing the fuel source and a second of the chambers containing the oxidizer source;
wherein the electrodes and the housing are moved relative to one another to affect said relative movement between the electrodes and the fuel and oxidizer sources.

20. A method according to claim 19, wherein the electrodes are provided on a disc and wherein the driver rotates the disc about a driving axis, the chambers each having an opening and the disc being positioned adjacent the openings so that the electrolytes of the electrodes are exposed to the fuel and oxidizer sources in the chambers through the openings,
wherein the rotation of the disc switches the electrodes between the anode condition with exposure to the fuel source in the first chamber and the cathode condition with exposure to the oxidizer source in the second chamber.

21. A method according to claim 19, wherein the fuel cell further comprises at least one negative electrode contact and at least one positive electrode contact,
each of the at least one negative electrode contacts contacting an electrode in the anode condition to conduct electrons to the load,
each of the at least one positive electrode contacts contacting an electrode in the cathode condition to conduct electrons from the load.

22. A method according to claim 21, wherein the at least one negative electrode contact is a plurality of negative electrode contacts coupled to a negative terminal and wherein the at least one positive contact is a plurality of positive electrode contacts coupled to a positive terminal,
wherein the negative electrode contacts contact a plurality of the electrodes in the anode condition, and
wherein the positive electrode contacts contact a plurality of the electrodes in the cathode condition.

23. A method according to claim 22, wherein the driver is an electric motor coupled to the negative and positive terminals, wherein the motor is operated using current across the positive and negative terminals.

24. A method according to claim 16, wherein the fuel cell is configured to operate in a temperature range from about 25° C. to about 500° C.

25. A method according to claim 16, wherein the fuel cell is configured to operate in a pressure range from about 1 psi to about 1000 psi.
